(19) United States
(12) Patent Application Publication
(10) Pub. No.: US 2021/0273374 A1
(43) Pub. Date: Sep. 2, 2021

(54) CONNECTOR

(71) Applicant: Yazaki Corporation, Tokyo (JP)

(72) Inventors: Yasuhiro Tanaka, Shizuoka (JP); Noboru Hayasaka, Shizuoka (JP); Hiroaki Ono, Shizuoka (JP); Toru Suzuki, Shizuoka (JP); Tatsuya Hosono, Shizuoka (JP); Kazuya Takeda, Shizuoka (JP)

(21) Appl. No.: 17/182,240

(22) Filed: Feb. 23, 2021

(30) Foreign Application Priority Data
Feb. 28, 2020 (JP) 2020-033409

(51) Int. Cl. H01R 13/52

(52) U.S. Cl. CPC H01R 13/5219

(57) ABSTRACT

A connector includes: a terminal metal fitting; a housing storing therein the terminal metal fitting and including an engaging portion inserted into a hole-shaped counterpart engaging portion from a front end and engaged with the counterpart engaging portion; and a tubular watertight member that is mounted on an outer circumferential surface of the engaging portion to fill a tubular gap between the engaging portion and the counterpart engaging portion in an inserting and engaging state and that includes a ring-shaped outer circumferential lip on an outer circumferential side, the outer circumferential lip being elastically deformed to come into close contact with an inner circumferential surface of the counterpart engaging portion.

### CROSS-REFERENCE TO RELATED APPLICATION(S)

The present application claims priority to and incorporates by reference the entire contents of Japanese Patent Application No. 2020-033409 filed in Japan on Feb. 28, 2020.

### BACKGROUND OF THE INVENTION

### 1. Field of the Invention

The present invention relates to a connector.

### 2. Description of the Related Art

A conventional connector is known that includes a terminal metal fitting, a housing storing therein the terminal metal fitting and including a tubular engaging portion, and a tubular watertight member mounted on an outer circumferential surface of the engaging portion. By inserting the engaging portion into a counterpart engaging portion shaped into a hole and by bringing the watertight member into close contact with an inner circumferential surface of the counterpart engaging portion, the engaging portion of the connector is engaged with and connected to the counterpart engaging portion. A connector of this type is disclosed in, for example, Japanese Patent No. 4379411.

The connector in Japanese Patent No. 4379411 includes a housing that includes a stopper disposed facing a watertight member in an axial direction and expanding in a circumferential direction and a protrusion protruding from the stopper toward the watertight member in the axial direction, in order to apply, to the watertight member, force against frictional resistance between the watertight member and an inner circumferential surface of a counterpart engaging portion when the connector is removed from the counterpart engaging portion. When the connector in Japanese Patent No. 4379411 is removed from the counterpart engaging portion, the watertight member is brought into contact with the stopper and the protrusion, thereby applying force against the frictional resistance between the watertight member and the inner circumferential surface of the counterpart engaging portion, from the stopper and the protrusion to the watertight member. Unfortunately, the connector used under high temperature conditions or the like may be affected by heat, causing the watertight member to adhere to the inner circumferential surface of the counterpart engaging portion. The adhering watertight member cannot be detached from the inner circumferential surface of the counterpart engaging portion without applying force greater than the force caused by the frictional resistance. For example, in the connector in Japanese Patent No. 4379411, force is applied over a wide area from the stopper and the protrusion to the watertight member and the force is thus spread, failing to detach the adhering watertight member from the inner circumferential surface of the counterpart engaging portion.

### SUMMARY OF THE INVENTION

An object of the present invention is to provide a connector enabling an adhering watertight member to be detached.

In order to achieve the above mentioned object, a connector according to one aspect of the present invention includes a terminal metal fitting; a housing storing therein the terminal metal fitting and including an engaging portion configured to be inserted into a hole-shaped counterpart engaging portion from a front end of the engaging portion and engaged with the counterpart engaging portion; and a watertight member shaped into a tube, the watertight member being mounted on an outer circumferential surface of the engaging portion to fill a tubular gap between the engaging portion and the counterpart engaging portion in an inserting and engaging state, the watertight member including an outer circumferential lip shaped into a ring and disposed on an outer circumferential side of the watertight member, the outer circumferential lip being configured to be elastically deformed to come into close contact with an inner circumferential surface of the counterpart engaging portion, the housing including a protruding portion disposed on a side with the front end with respect to the watertight member mounted on the outer circumferential surface of the engaging portion, the protruding portion being configured to come into contact with the watertight member upon pulling-out of the engaging portion from the counterpart engaging portion and to transmit force in a pulling-out direction to the outer circumferential lip to detach the outer circumferential lip adhering to the inner circumferential surface of the counterpart engaging portion, and at least two of the protruding portions being disposed at an interval in a circumferential direction of the outer circumferential surface of the engaging portion.

According to another aspect of the present invention, in the connector, it is possible to configure that two of the protruding portions adjacent to each other in the circumferential direction of the outer circumferential surface of the engaging portion are arranged in such a positional relation that a flexural deformation region, deformed by one of the two protruding portions, of the watertight member does not overlap with a flexural deformation region, deformed by the other protruding portion, of the watertight member.

According to still another aspect of the present invention, in the connector, it is possible to configure that two of the protruding portions adjacent to each other in the circumferential direction of the outer circumferential surface of the engaging portion are arranged in such a positional relation that, when viewed in an axial direction of a central axis common to the engaging portion and the watertight member, the two protruding portions form an included angle with the central axis being a vertex.

According to still another aspect of the present invention, in the connector, it is possible to configure that the protruding portions are configured to be pressed into the watertight member by the force in the pulling-out direction and to form pressed portions at starting points of deformation in the watertight member, the pressed portions being shaped into valleys having an included angle.

According to still another aspect of the present invention, in the connector, it is possible to configure that the protruding portions have a length in a direction in which the engaging portion is inserted into and pulled out from the counterpart engaging portion greater than a width in the circumferential direction of the outer circumferential surface of the engaging portion.

According to still another aspect of the present invention, in the connector, it is possible to configure that the housing includes an escape space portion disposed between two of the protruding portions adjacent to each other in the circumferential direction of the outer circumferential surface of the engaging portion, the escape space portion being configured to prevent the watertight member from coming into contact until the protruding portions detach the outer circumferential lip from the inner circumferential surface of the counterpart engaging portion.

According to still another aspect of the present invention, in the connector, it is possible to configure that the outer circumferential surface of the engaging portion serves as an outer circumferential surface of a circular tube, and the watertight member is formed into a circular tube.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a connector according to an embodiment, attached to a counterpart engaging portion;

FIG. 2 is a perspective view illustrating the connector according to the embodiment, before attached to the counterpart engaging portion;

FIG. 3 is a partially enlarged view of a section taken along line X-X in FIG. 1;

FIG. 4 is a diagram of a portion of a housing and a watertight member viewed from the outside in a radial direction;

FIG. 5 is an exploded perspective view of the portion of the housing and the watertight member;

FIG. 6 is a sectional view taken along line X-X in FIG. 5;

FIG. 7 is a schematic view illustrating an example state of deformation of the watertight member by protruding portions; and

FIG. 8 is a sectional view illustrating an example process of deformation of the watertight member by the protruding portions.

### DETAILED DESCRIPTION OF THE PREFERRED EMBODIMENTS

Embodiments of a connector according to the present invention will now be described in detail with reference to the accompanying drawings. Note that the embodiments should not be construed to limit the present invention.

### Embodiments

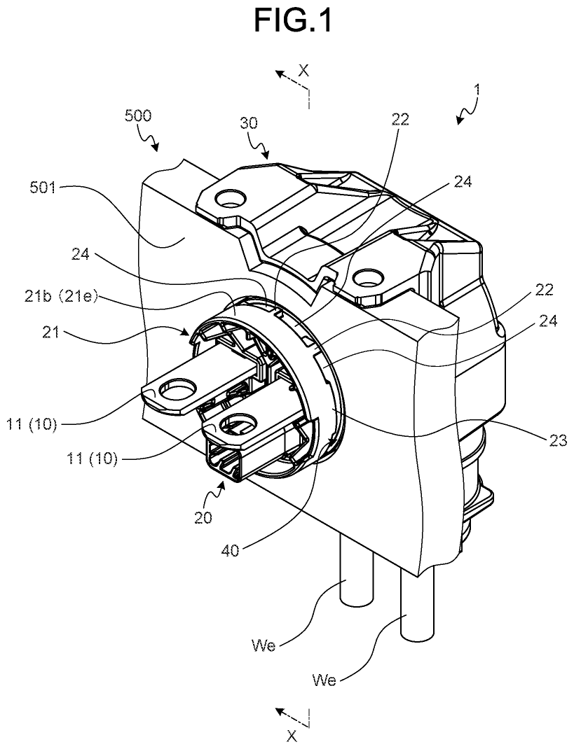

An embodiment of the connector according to the present invention will be described with reference to FIG. 1 to FIG. 8.

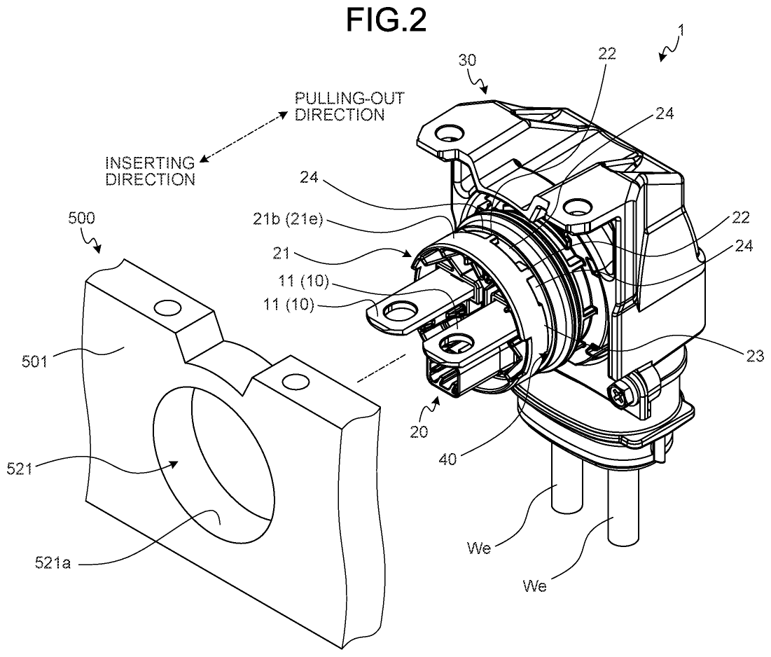

Reference sign 1 in FIG. 1 and FIG. 2 denotes a connector according to the present embodiment. The connector 1 is inserted into and engaged with an interior of a counterpart engaging portion 521 shaped into a hole and including an inner circumferential surface 521a, and is electrically connected to a counterpart terminal metal fitting (not illustrated) (FIG. 1 and FIG. 2). The connector 1 is inserted into and pulled out from the hole-shaped counterpart engaging portion 521 in a hole-axial direction of the counterpart engaging portion 521. The counterpart engaging portion 521 is formed having a circular or oval cross section orthogonal to the hole-axial direction, for example. Note that the counterpart engaging portion 521 may be shaped into a tube, and an engaging portion 21 may be inserted into and engaged with an interior space of the tube.

For example, the connector 1 is electrically connected to a counterpart terminal metal fitting of a counterpart device 500 to electrically connect the counterpart device 500 to a device (not illustrated) on the other side of electric wires We (FIG. 1 and FIG. 2). The counterpart device 500 includes a metal case 501, and a through hole formed in a wall body of the case 501 is used as the counterpart engaging portion 521. The counterpart device 500 further includes a terminal block or a counterpart connector (not illustrated) disposed inside the case 501. The terminal block or counterpart connector includes the counterpart terminal metal fitting. Thus, the connector 1 is inserted into and engaged with the interior of the counterpart engaging portion 521, and is electrically connected to the counterpart terminal metal fitting of the terminal block or counterpart connector inside the case 501.

The connector 1 includes terminal metal fittings 10, a housing 20, and a shield shell 30 (FIG. 1 and FIG. 2).

The terminal metal fittings 10 are formed from an electrically conductive material, such as metal. For example, the terminal metal fittings 10 are formed into a predetermined shape by subjecting a metal plate serving as a base material to pressing, such as bending and cutting. The terminal metal fittings 10 are physically and electrically connected to ends of the electric wires We. By inserting the connector 1 into the counterpart engaging portion 521, terminal connecting portions 11 of the terminal metal fittings 10 are stored in the case 501 of the counterpart device 500 (FIG. 1 and FIG. 2). By physically and electrically connecting the terminal connecting portions 11 to the counterpart terminal metal fitting in the case 501 and by establishing electrical connection between the terminal metal fittings 10 and the counterpart terminal metal fitting, the connector 1 electrically connects the counterpart device 500 to the device on the other side of the electric wires We.

The housing 20 is a storing member formed from an insulating material, such as synthetic resin. The housing 20 stores therein the terminal metal fittings 10 and the electric wires We. The terminal metal fittings 10 are held in an interior of the housing 20, and the electric wires We extend outward from the interior. The housing 20 is covered, from the outside, with the shield shell 30 made from metal to prevent noise from coming in the terminal metal fittings 10 and the electric wires We in the interior (FIG. 1 and FIG. 2).

The housing 20 includes the engaging portion 21 that is inserted into the counterpart engaging portion 521 from a front end 21e and that is engaged with the counterpart engaging portion 521 (FIG. 1 to FIG. 5). The engaging portion 21 is shaped into a tube, and the terminal connecting portions 11 protrude from an interior of the engaging portion 21 in a tube-axial direction.

The engaging portion 21 is shaped into a circular tube conforming to the shape of the counterpart engaging portion 521 or into an oval tube having an oval ring cross section orthogonal to the tube-axial direction, and is smaller than the hole of the counterpart engaging portion 521. Thus, a tubular gap is defined between the engaging portion 21 and the counterpart engaging portion 521 in an inserting and engaging state. The connector 1 includes a tubular watertight member 40 for preventing water from entering the case 501 through the tubular gap (FIG. 1 to FIG. 4).

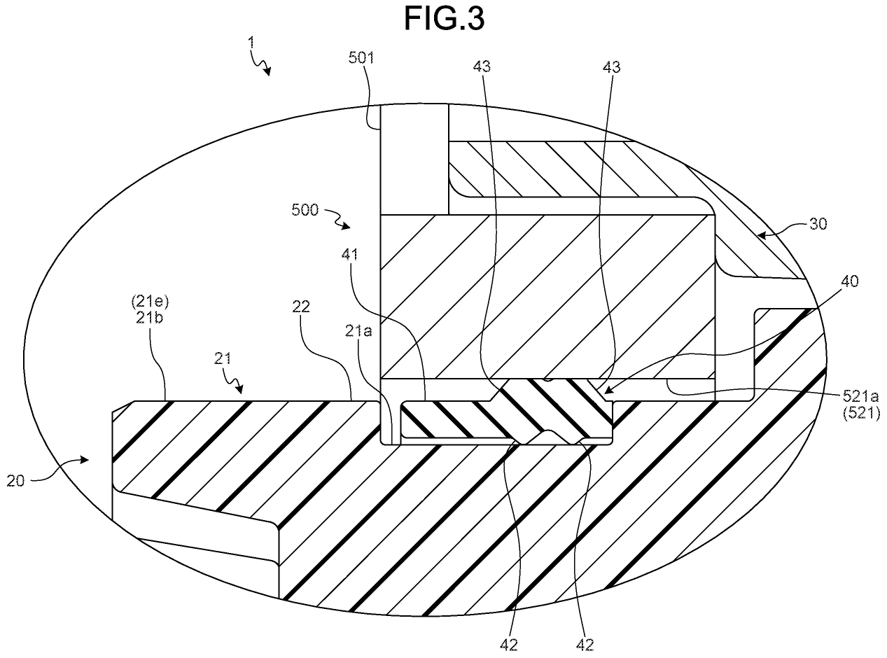

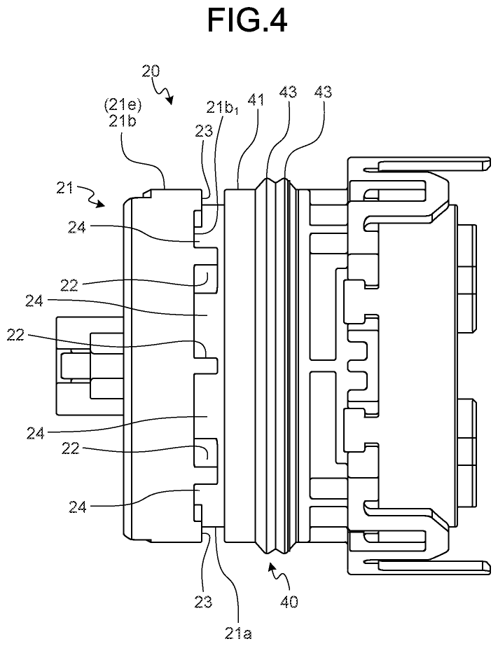

The watertight member 40 is formed from an elastically deformable synthetic resin material, such as rubber. The watertight member 40 is mounted on an outer circumferential surface 21a of the engaging portion 21 to fill the tubular gap between the engaging portion 21 and the counterpart engaging portion 521 in the inserting and engaging state (FIG. 3 and FIG. 4).

The watertight member 40 includes a base portion 41 shaped into a tube, a coaxial ring-shaped lip (hereinafter referred to as an “inner circumferential lip”) 42 protruding from an inner circumferential surface of the base portion 41, and a coaxial ring-shaped lip (hereinafter referred to as an “outer circumferential lip”) 43 protruding from an outer circumferential surface of the base portion 41 (FIG. 3 and FIG. 4). In the watertight member 40, a plurality of the inner circumferential lips 42 and a plurality of the outer circumferential lips 43 are arranged in a tube-axial direction of the base portion 41. The watertight member 40 described here includes two inner circumferential lips 42 and two outer circumferential lips 43. When the watertight member 40 is mounted on the outer circumferential surface 21a of the engaging portion 21, the inner circumferential lips 42 on the inner circumferential side of the watertight member 40 are elastically deformed to come into close contact with the outer circumferential surface 21a of the engaging portion 21 (FIG. 3). Furthermore, when the engaging portion 21 and the counterpart engaging portion 521 are in the inserting and engaging state, the outer circumferential lips 43 on the outer circumferential side of the watertight member 40 are elastically deformed to come into close contact with the inner circumferential surface 521a of the counterpart engaging portion 521 (FIG. 3).

The engaging portion 21 described here is formed into a circular tube having a smaller outer diameter than the counterpart engaging portion 521, in conformance to the counterpart engaging portion 521 formed as the through hole having a columnar shape. That is, the outer circumferential surface 21a of the engaging portion 21 serves as an outer circumferential surface of the circular tube. The watertight member 40 is formed into a circular tube to fill the gap having a circular tube shape between the engaging portion 21 and the counterpart engaging portion 521 in the inserting and engaging state. That is, the watertight member 40 described here includes the base portion 41 shaped into a circular tube, the inner circumferential lips 42 shaped into circular rings, and the outer circumferential lips 43 shaped into circular rings.

The watertight member 40 used under high temperature conditions or the like and affected by heat may cause the inner circumferential lips 42 to adhere to the outer circumferential surface 21a of the engaging portion 21 and the outer circumferential lips 43 to adhere to the inner circumferential surface 521a of the counterpart engaging portion 521. Thus, if, in the watertight member 40, only the outer circumferential lips 43 adhere to the inner circumferential surface 521a of the counterpart engaging portion 521, or if adhering force of the outer circumferential lips 43 to the inner circumferential surface 521a of the counterpart engaging portion 521 is greater than adhering force of the inner circumferential lips 42 to the outer circumferential surface 21a of the engaging portion 21, the watertight member 40 may come off the engaging portion 21 and remain attached to the inner circumferential surface 521a of the counterpart engaging portion 521 when the engaging portion 21 is pulled out from the counterpart engaging portion 521.

Therefore, in the connector 1, a design is added to the housing 20 to prevent the watertight member 40 from coming off in the aforementioned manner. The housing 20 includes protruding portions 22 that are disposed on the front end 21e side with respect to the watertight member 40 mounted on the outer circumferential surface 21a of the engaging portion 21 and that come into contact with the watertight member 40 when the engaging portion 21 is pulled out from the counterpart engaging portion 521 and transmit force in the pulling-out direction to the outer circumferential lips 43 to detach the outer circumferential lips 43 adhering to the inner circumferential surface 521a of the counterpart engaging portion 521 (FIG. 1 to FIG. 5).

The protruding portions 22 are disposed facing an end surface, on the front end 21e side in the tube-axial direction, of the base portion 41 in the tube-axial direction (FIG. 1 to FIG. 4). At least two protruding portions 22 are disposed at an interval in a circumferential direction of the outer circumferential surface 21a of the engaging portion 21 (FIG. 1 to FIG. 6).

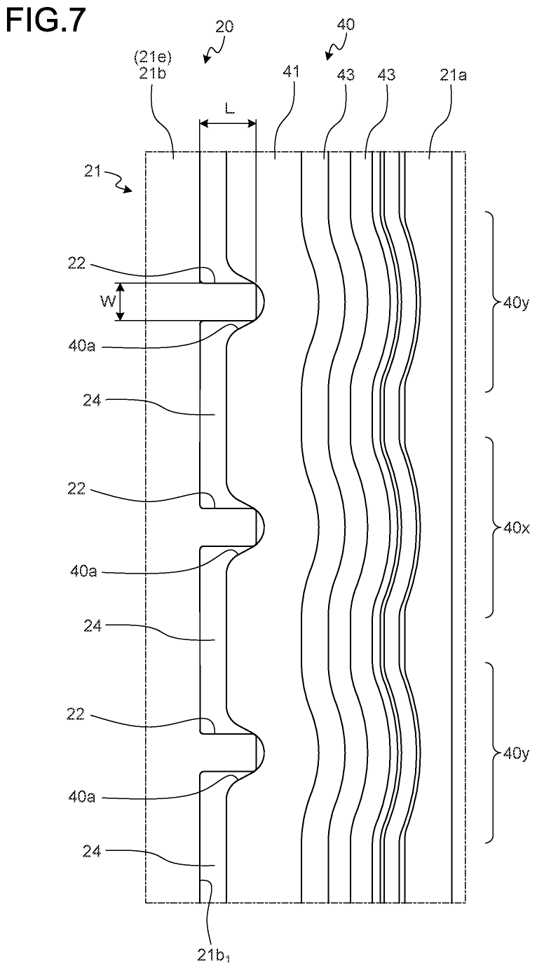

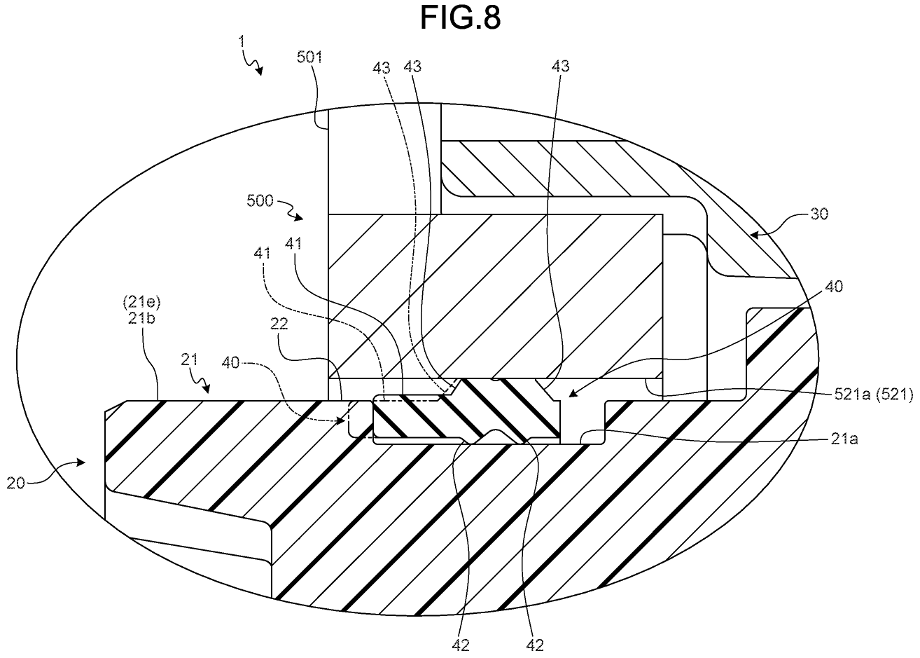

Furthermore, the protruding portions 22 are formed into such a shape that, when the engaging portion 21 is pulled out from the counterpart engaging portion 521, the protruding portions 22 can apply localized force to the circular-ring-shaped end surface, on the front end 21e side in the tube-axial direction, of the base portion 41 and can be pressed into the watertight member 40 by the force in the pulling-out direction in pulling out the engaging portion 21 from the counterpart engaging portion 521 (FIG. 7). For example, the protruding portions 22 are pressed into the watertight member 40 by the force in the pulling-out direction and form pressed portions 40a shaped into valleys having an included angle at starting points of deformation in the watertight member 40, thereby applying localized force to the circular-ring-shaped end surface of the base portion 41 and transmitting the force to the outer circumferential lips 43. The starting points of deformation in the watertight member 40 indicate portions of the watertight member 40 that first come into contact with the protruding portions 22 and start deforming. Herein, the starting points of deformation are located on the base portion 41. Thus, the protruding portions 22 can apply localized force to the outer circumferential lips 43 adhering to the inner circumferential surface 521a of the counterpart engaging portion 521 in the circumferential direction and can locally deform the outer circumferential lips 43 (FIG. 7 and FIG. 8), so that portions of the adhering outer circumferential lips 43 can be detached from the inner circumferential surface 521a of the counterpart engaging portion 521. The protruding portions 22 then continue applying the localized force to the circular-ring-shaped end surface of the base portion 41, thereby using the portions detached from the inner circumferential surface 521a of the counterpart engaging portion 521 as starting points to detach adhering portions, in the vicinities of the starting points, of the outer circumferential lips 43 from the inner circumferential surface 521a of the counterpart engaging portion 521. In this way, the protruding portions 22 can expand detached portions, detached from the inner circumferential surface 521a of the counterpart engaging portion 521, of the outer circumferential lips 43, thus enabling the watertight member 40 to be pulled out from the counterpart engaging portion 521 together with the engaging portion 21. Note that FIG. 8 illustrates an example process of deformation of the watertight member 40. In FIG. 8, the watertight member 40 before deformation is represented by a chain double-dashed line.

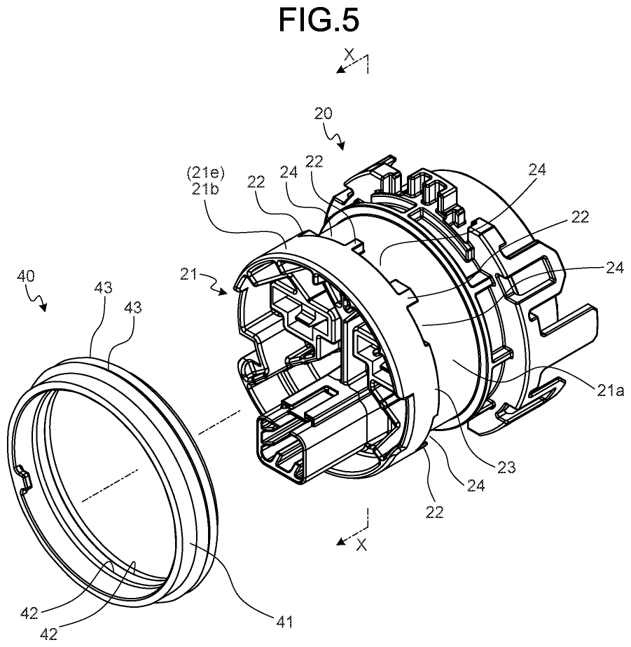

The protruding portions 22 described here have a length L in a direction in which the engaging portion 21 is inserted into and pulled out from the counterpart engaging portion 521 greater than a width W in the circumferential direction of the outer circumferential surface 21a of the engaging portion 21 (FIG. 1, FIG. 2, FIG. 4, FIG. 5, and FIG. 7). Thus, by adjusting the width W in the circumferential direction, for example, the protruding portions 22 can be adjusted to have a shape enabling generation of desired localized force necessary to detach the adhering outer circumferential lips 43.

Furthermore, the two protruding portions 22 adjacent to each other in the circumferential direction of the outer circumferential surface 21a of the engaging portion 21 are preferably arranged in such a positional relation that a flexural deformation region 40x, deformed by one of the protruding portions 22, of the watertight member 40 does not overlap with a flexural deformation region 40y, deformed by the other protruding portion 22, of the watertight member 40 (FIG. 7). For example, it is difficult for the two adjacent protruding portions 22 disposed too close to apply localized force to the circular-ring-shaped end surface of the base portion 41. Thus, the two adjacent protruding portions 22 are arranged in the aforementioned positional relation, so that each of the protruding portions 22 can apply localized force to the circular-ring-shaped end surface of the base portion 41, thereby effectively detaching the adhering outer circumferential lips 43.

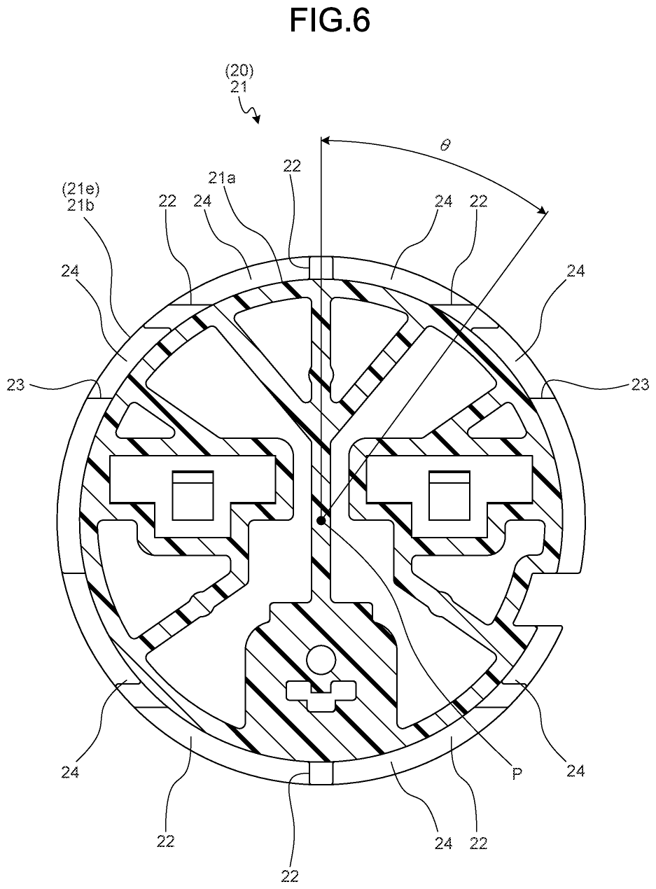

Furthermore, the at least two protruding portions 22 adjacent to each other in the circumferential direction of the outer circumferential surface 21a of the engaging portion 21 are preferably arranged in such a positional relation that, when viewed in an axial direction of a central axis P common to the engaging portion 21 and the watertight member 40, the protruding portions 22 form an included angle with the central axis P being the vertex (FIG. 6). For example, the at least two adjacent protruding portions 22 are arranged so that an angle 0 formed by lines connecting the centers of the widths W, in the circumferential direction, of the protruding portions 22 to the central axis P is an included angle. With this arrangement, the at least two adjacent protruding portions 22 do not allow a portion of the outer circumferential lips 43, between respective detached portions of the outer circumferential lips 43 detached from the inner circumferential surface 521a of the counterpart engaging portion 521, to remain adhering to the inner circumferential surface 521a over a wide area. Thus, the at least two adjacent protruding portions 22 can generate a detached portion over a wide area by connecting the respective detached portions of the outer circumferential lips 43, for example, so that the watertight member 40 can be pulled out from the counterpart engaging portion 521 together with the engaging portion 21. Furthermore, with the at least two adjacent protruding portions 22, even if an adhering portion remains between the respective detached portions of the outer circumferential lips 43, for example, the adhering portion is small, so that the adhering portion is detached from the inner circumferential surface 521a of the counterpart engaging portion 521 by continuously pulling the engaging portion 21 in the pulling-out direction, thus enabling the watertight member 40 to be pulled out from the counterpart engaging portion 521 together with the engaging portion 21.

After the entire watertight member 40 or a portion of the watertight member 40 is detached from the inner circumferential surface 521a of the counterpart engaging portion 521 using the protruding portions 22, the watertight member 40 may be pulled out from the counterpart engaging portion 521 together with the engaging portion 21 with the protruding portions 22 being caught on the watertight member 40.

In addition, the housing 20 may include a pushing protrusion 23 that comes into contact with the watertight member 40 detached from the inner circumferential surface 521a of the counterpart engaging portion 521 using the protruding portions 22 and applies pushing force to the watertight member 40 in the pulling-out direction (FIG. 1, FIG. 2, FIG. 4, and FIG. 5). The pushing protrusion 23 includes an end surface on the watertight member 40 side in the tube-axial direction (the tube-axial direction of the engaging portion 21) located on the front end 21e side with respect to end surfaces, on the watertight member 40 side, of the protruding portions 22, and is disposed in such a position that the pushing protrusion 23 does not come into contact with the watertight member 40 before the protruding portions 22 detach the outer circumferential lips 43 from the inner circumferential surface 521a of the counterpart engaging portion 521.

The housing 20 further includes an escape space portion 24 that is disposed between the two protruding portions 22 adjacent to each other in the circumferential direction of the outer circumferential surface 21a of the engaging portion 21 and that prevents the watertight member 40 from coming into contact until the protruding portions 22 detach the outer circumferential lips 43 from the inner circumferential surface 521a of the counterpart engaging portion 521 (FIG. 1, FIG. 2, and FIG. 4 to FIG. 7). A portion, between the pressed portions 40a pressed by the protruding portions 22, of the watertight member 40 escapes to the escape space portion 24 without coming into contact with the housing 20 in the tube-axial direction. Thus, the two adjacent protruding portions 22 each can apply localized force to the circular-ring-shaped end surface of the base portion 41 and can effectively detach the adhering outer circumferential lips 43. This escape space portion 24 is preferably also disposed between the protruding portion 22 and the pushing protrusion 23 adjacent to each other.

On the outer circumferential surface 21a of the engaging portion 21 described here, three protruding portions 22 are disposed on one side in a radial direction with respect to the central axis P while forming included angles between one another, and three protruding portions 22 are disposed on the other side in the radial direction with respect to the central axis P while forming included angles between one another (FIG. 5).

Furthermore, on the outer circumferential surface 21a of the engaging portion 21 described here, two gaps are defined between a group of protrusions consisting of the three protruding portions 22 on one side in the circumferential direction and a group of protrusions consisting of the three protruding portion 22 on the other side. On the outer circumferential surface 21a of the engaging portion 21 described here, one pushing protrusion 23 is disposed in each of the gaps. The pushing protrusion 23 described here has a width in the circumferential direction of the outer circumferential surface 21a of the engaging portion 21 greater than a length in the direction in which the engaging portion 21 is inserted into and pulled out from the counterpart engaging portion 521.

The engaging portion 21 described here further includes a tube portion 21b disposed at the front end 21e and shaped into a circular tube that has a larger diameter than the outer circumferential surface 21a and that is smaller than the hole of the counterpart engaging portion 521 (FIG. 1 to FIG. 5). In the engaging portion 21, the protruding portions 22 and the pushing protrusion 23 protrude from a circular-ring-shaped end surface 21b₁, on the watertight member 40 side, of the tube portion 21b toward the watertight member 40 (FIG. 4). Thus, in the engaging portion 21 described here, space surrounded by the two adjacent protruding portions 22 and the end surface 21b₁ of the tube portion 21b serves as the escape space portion 24. Furthermore, in the engaging portion 21 described here, space surrounded by the protruding portion 22 and the pushing protrusion 23 adjacent to each other and the end surface 21b₁ of the tube portion 21b serves as the escape space portion 24.

As described above, with the connector 1 according to the present embodiment, when the engaging portion 21 is pulled out from the counterpart engaging portion 521, the protruding portions 22 can locally detach the adhering outer circumferential lips 43 from the inner circumferential surface 521a of the counterpart engaging portion 521 and can expand detached portions, detached from the inner circumferential surface 521a of the counterpart engaging portion 521, of the outer circumferential lips 43, enabling the watertight member 40 adhering to the inner circumferential surface 521a to be detached. Thus, with the connector 1, the engaging portion 21 when pulled out from the counterpart engaging portion 521 can be pulled out from the counterpart engaging portion 521 together with the watertight member 40.

With the connector according to the present embodiment, when the engaging portion is pulled out from the counterpart engaging portion, the protruding portions can locally detach the adhering outer circumferential lips from the inner circumferential surface of the counterpart engaging portion and can expand detached portions of the outer circumferential lips, detached from the inner circumferential surface of the counterpart engaging portion, enabling the watertight member adhering to the inner circumferential surface to be detached. Thus, with the connector, the engaging portion when pulled out from the counterpart engaging portion can be pulled out from the counterpart engaging portion together with the watertight member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a terminal metal fitting;
a housing storing therein the terminal metal fitting and including an engaging portion configured to be inserted into a hole-shaped counterpart engaging portion from a front end of the engaging portion and engaged with the counterpart engaging portion; and
a watertight member shaped into a tube, the watertight member being mounted on an outer circumferential surface of the engaging portion to fill a tubular gap between the engaging portion and the counterpart engaging portion in an inserting and engaging state, the watertight member including an outer circumferential lip shaped into a ring and disposed on an outer circumferential side of the watertight member, the outer circumferential lip being configured to be elastically deformed to come into close contact with an inner circumferential surface of the counterpart engaging portion,
the housing including a protruding portion disposed on a side with the front end with respect to the watertight member mounted on the outer circumferential surface of the engaging portion, the protruding portion being configured to come into contact with the watertight member upon pulling-out of the engaging portion from the counterpart engaging portion and to transmit force in a pulling-out direction to the outer circumferential lip to detach the outer circumferential lip adhering to the inner circumferential surface of the counterpart engaging portion, and
at least two of the protruding portions being disposed at an interval in a circumferential direction of the outer circumferential surface of the engaging portion.

2. The connector according to claim 1, wherein
two of the protruding portions adjacent to each other in the circumferential direction of the outer circumferential surface of the engaging portion are arranged in such a positional relation that a flexural deformation region, deformed by one of the two protruding portions, of the watertight member does not overlap with a flexural deformation region, deformed by the other protruding portion, of the watertight member.

3. The connector according to claim 1, wherein
two of the protruding portions adjacent to each other in the circumferential direction of the outer circumferential surface of the engaging portion are arranged in such a positional relation that, when viewed in an axial direction of a central axis common to the engaging portion and the watertight member, the two protruding portions form an included angle with the central axis being a vertex.

4. The connector according to claim 2, wherein
two of the protruding portions adjacent to each other in the circumferential direction of the outer circumferential surface of the engaging portion are arranged in such a positional relation that, when viewed in an axial direction of a central axis common to the engaging portion and the watertight member, the two protruding portions form an included angle with the central axis being a vertex.

5. The connector according to claim 1, wherein
the protruding portions are configured to be pressed into the watertight member by the force in the pulling-out direction and to form pressed portions at starting points of deformation in the watertight member, the pressed portions being shaped into valleys having an included angle.

6. The connector according to claim 2, wherein
the protruding portions are configured to be pressed into the watertight member by the force in the pulling-out direction and to form pressed portions at starting points of deformation in the watertight member, the pressed portions being shaped into valleys having an included angle.

7. The connector according to claim 3, wherein
the protruding portions are configured to be pressed into the watertight member by the force in the pulling-out direction and to form pressed portions at starting points of deformation in the watertight member, the pressed portions being shaped into valleys having an included angle.

8. The connector according to claim 1, wherein
the protruding portions have a length in a direction in which the engaging portion is inserted into and pulled out from the counterpart engaging portion greater than a width in the circumferential direction of the outer circumferential surface of the engaging portion.

9. The connector according to claim 2, wherein
the protruding portions have a length in a direction in which the engaging portion is inserted into and pulled out from the counterpart engaging portion greater than a width in the circumferential direction of the outer circumferential surface of the engaging portion.

10. The connector according to claim 3, wherein
the protruding portions have a length in a direction in which the engaging portion is inserted into and pulled out from the counterpart engaging portion greater than a width in the circumferential direction of the outer circumferential surface of the engaging portion.

11. The connector according to claim 5, wherein
the protruding portions have a length in a direction in which the engaging portion is inserted into and pulled out from the counterpart engaging portion greater than a width in the circumferential direction of the outer circumferential surface of the engaging portion.

12. The connector according to claim 1, wherein
the housing includes an escape space portion disposed between two of the protruding portions adjacent to each other in the circumferential direction of the outer circumferential surface of the engaging portion, the escape space portion being configured to prevent the watertight member from coming into contact until the protruding portions detach the outer circumferential lip from the inner circumferential surface of the counterpart engaging portion.

13. The connector according to claim 2, wherein
the housing includes an escape space portion disposed between two of the protruding portions adjacent to each other in the circumferential direction of the outer circumferential surface of the engaging portion, the escape space portion being configured to prevent the watertight member from coming into contact until the protruding portions detach the outer circumferential lip from the inner circumferential surface of the counterpart engaging portion.

14. The connector according to claim 3, wherein
the housing includes an escape space portion disposed between two of the protruding portions adjacent to each other in the circumferential direction of the outer circumferential surface of the engaging portion, the escape space portion being configured to prevent the watertight member from coming into contact until the protruding portions detach the outer circumferential lip from the inner circumferential surface of the counterpart engaging portion.

15. The connector according to claim 5, wherein
the housing includes an escape space portion disposed between two of the protruding portions adjacent to each other in the circumferential direction of the outer circumferential surface of the engaging portion, the escape space portion being configured to prevent the watertight member from coming into contact until the protruding portions detach the outer circumferential lip from the inner circumferential surface of the counterpart engaging portion.

16. The connector according to claim 8, wherein
the housing includes an escape space portion disposed between two of the protruding portions adjacent to each other in the circumferential direction of the outer circumferential surface of the engaging portion, the escape space portion being configured to prevent the watertight member from coming into contact until the protruding portions detach the outer circumferential lip from the inner circumferential surface of the counterpart engaging portion.

17. The connector according to claim 1, wherein
the outer circumferential surface of the engaging portion serves as an outer circumferential surface of a circular tube, and
the watertight member is formed into a circular tube.

18. The connector according to claim 2, wherein
the outer circumferential surface of the engaging portion serves as an outer circumferential surface of a circular tube, and
the watertight member is formed into a circular tube.

19. The connector according to claim 3, wherein
the outer circumferential surface of the engaging portion serves as an outer circumferential surface of a circular tube, and
the watertight member is formed into a circular tube.

20. The connector according to claim 5, wherein
the outer circumferential surface of the engaging portion serves as an outer circumferential surface of a circular tube, and
the watertight member is formed into a circular tube.
